(19) United States
(12) Patent Application Publication
(10) Pub. No.: US 2013/0154417 A1
(43) Pub. Date: Jun. 20, 2013

(54) SPINDLE MOTOR

(71) Applicant: Samsung Electro-Mechanics Co., Ltd., Suwon (KR)

(72) Inventor: Hoon Hee HAN, Suwon (KR)

(73) Assignee: Samsung Electro-Mechanics Co., Ltd., Suwon (KR)

(21) Appl. No.: 13/710,736

(22) Filed: Dec. 11, 2012

(30) Foreign Application Priority Data
Dec. 16, 2011 (KR) 10-2011-0136356

(51) Int. Cl. H02K 5/167

(52) U.S. Cl. CPC H02K 5/1675
USPC 310/90

(57) ABSTRACT

There is provided a spindle motor, including: a shaft directly or indirectly fixed to a base; a rotor hub rotatably disposed via oil while maintaining a bearing gap from the shaft and including a communicating part in communication with the outside so that a fluid-air interface is formed between the rotor hub and the shaft; and a compensating part formed by allowing a predetermined area of the rotor hub to be depressed so as to compensate for mass unbalance of the rotor hub due to the communicating part.

### CROSS-REFERENCE TO RELATED APPLICATIONS

This application claims the priority of Korean Patent Application No. 10-2011-0136356 filed on Dec. 16, 2011, in the Korean Intellectual Property Office, the disclosure of which is incorporated herein by reference.

### BACKGROUND OF THE INVENTION

1. Field of the Invention

The present invention relates to a spindle motor, and more particularly, to a motor that may be applied to a recording disk driving apparatus for a server rotating a recording disk.

2. Description of the Related Art

A recording disk driving apparatus for a server is generally provided with a so-called fixed shaft-type spindle motor in which a shaft having strong impact resistance is fixed to a case of the recording disk driving apparatus.

That is, the spindle motor provided in the recording disk driving apparatus for a server has a shaft fixedly mounted therein, for preventing the hard disk in the server from being damaged and being in a state in which data cannot be written to the disk or read therefrom due to an external impact.

When the fixed shaft is mounted as described above, in order to configure a fluid dynamic bearing assembly utilizing oil, a base and the shaft, fixed members, are generally required and a cover for shielding the fixed members and a sleeve and a hub, rotating members, are required.

In other words, in order to configure the fluid dynamic bearing assembly including the fixed shaft, many components are required, a required production process time may be inevitably increased, due to many components, and a total tolerance of the spindle motor may also be inevitably increased due to tolerances of the many components.

Further, in the case of the fluid dynamic bearing assembly including the fixed shaft according to the related art, a hole communicating with the outside is formed in the sleeve to form a fluid-air interface. In this case, it may be difficult to identify the position of the hole from the outside.

That is, the injection of oil needs to be performed at a position of the sleeve in which the hole is not formed. As it is difficult to identify the position of the hole from the outside, oil is likely to be injected at a position at which the hole is formed, such that the problem of a degradation in rotational characteristics may occur due to the oil filled in the hole.

Further, the hole may cause a mass unbalance in the sleeve to thereby cause rotational eccentricity, a deviation in rotations from a rotational center of the rotating member, at the time of the rotation of the rotating member, such that it is difficult to implement stable rotational characteristics.

Therefore, in the spindle motor including the fixed shaft, research into reducing the number of components to improve productivity and significantly reduce manufacturing tolerances while addressing the issue caused by the hole formed in the sleeve to significantly improve rotational characteristics has been urgently required.

Patent Document 1, disclosed in the following related art, forms a circulation hole in a sleeve, yet retains a problem in terms of rotational characteristics due to the circulation hole.

### RELATED ART DOCUMENT

(Patent Document 1) US Patent Application Publication No. 2005/0207060

### SUMMARY OF THE INVENTION

An aspect of the present invention provides a spindle motor capable of reducing the number of components included therein in order to improve productivity and significantly reduce manufacturing tolerances as well as improve rotational characteristics.

According to an aspect of the present invention, there is provided a spindle motor, including: a shaft directly or indirectly fixed to a base; a rotor hub rotatably disposed via oil while maintaining a bearing gap from the shaft and including a communicating part in communication with the outside so that a fluid-air interface is formed between the rotor hub and the shaft; and a compensating part formed by allowing a predetermined area of the rotor hub to be depressed so as to compensate for mass unbalance of the rotor hub due to the communicating part.

The compensating part may be symmetrically formed with regard to the communicating part, based on a rotational center of the rotor hub.

The compensating part and the communicating part may have the same volume.

The spindle motor may further include an upper thrust part and a lower thrust part fixed to the shaft and allowing the fluid-air interface to be formed.

The fluid-air interface formed in the upper thrust part may be formed between the upper thrust part and a seal part coupled to the rotor hub.

One surface of the seal part may be inclined downwardly in an inner radial direction so as to form the fluid-air interface together with the upper thrust part.

The compensating part may be formed outwardly of at least one of the upper thrust part and the lower thrust part in a radial direction.

The shaft may be provided with a separating groove depressed inwardly from an outer circumferential surface thereof so as to allow the oil provided in a gap formed between the rotor hub and the shaft to be separated upwardly and downwardly in an axial direction.

The communicating part may be disposed to face the separating groove to allow the separating groove to be in communication with the outside, and the fluid-air interface may be formed in upper and lower portions of the separating groove in the axial direction.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view illustrating a spindle motor according to an embodiment of the present invention;

FIG. 2 is a schematic enlarged cross-sectional view of portion A of FIG. 1;

FIG. 3 is a schematic exploded cutaway perspective view illustrating main components of the spindle motor according to the embodiment of the present invention; and

FIG. 4 is a schematic cutaway perspective view illustrating an oil filling process of a spindle motor according to an embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of components may be exaggerated for clarity, and the same reference numerals will be used throughout to designate the same or like components.

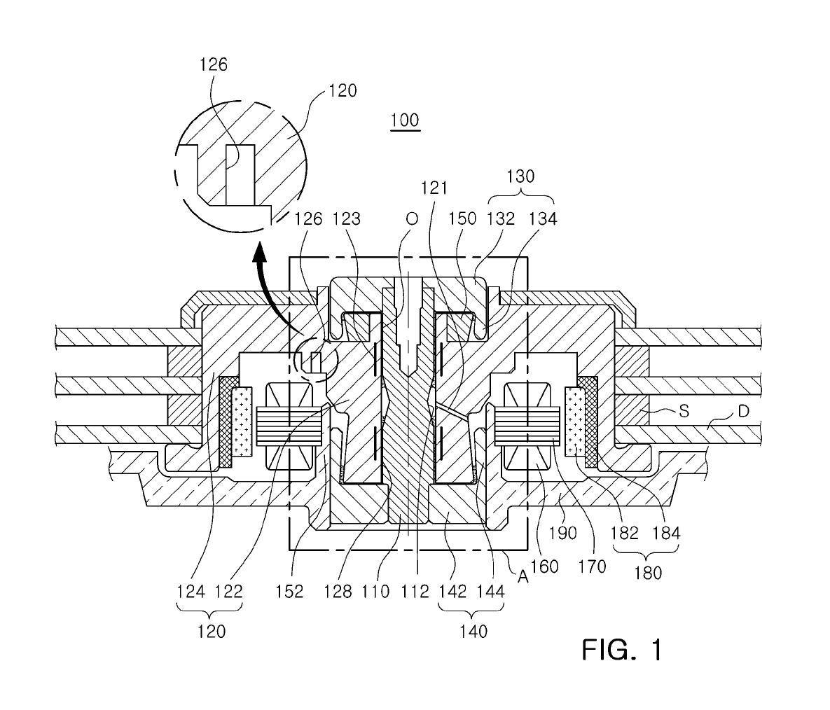

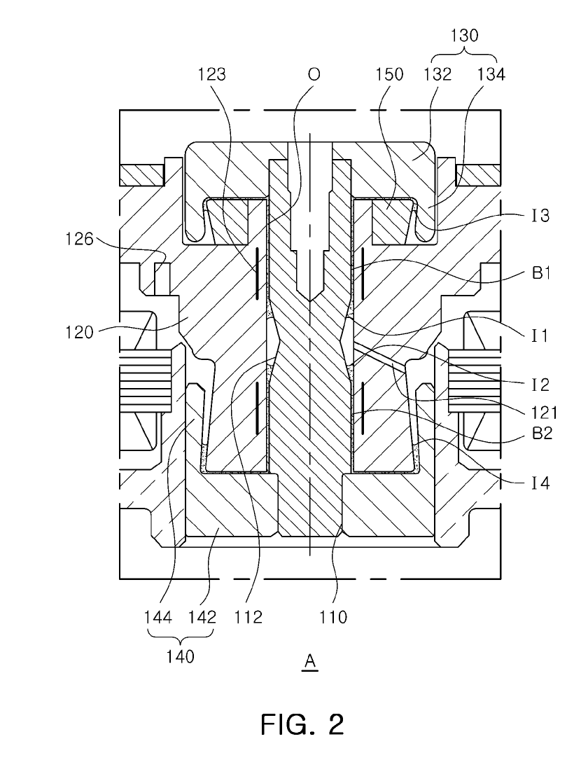

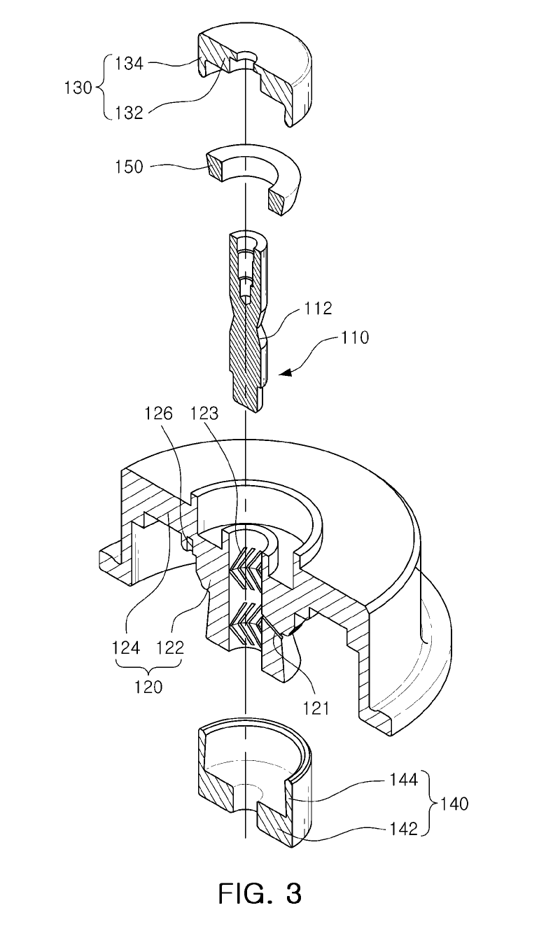

FIG. 1 is a schematic cross-sectional view illustrating a spindle motor according to an embodiment of the present invention, FIG. 2 is a schematic enlarged cross-sectional view of portion A of FIG. 1, and FIG. 3 is a schematic exploded cutaway perspective view illustrating main components of the spindle motor according to the embodiment of the present invention.

First, the terms with respect to directions will be defined. When viewed in FIG. 1, an axial direction may refer to a vertical direction based on a shaft 110, and an inner radial or outer radial direction may refer to a direction toward an outside of a rotor hub 120 or vice versa, based on the shaft 110.

Further, a circumferential direction may refer to a rotation direction of the rotor hub 120, that is, a direction corresponding to an outer circumferential surface of the rotor hub 120.

Referring to FIGS. 1 to 3, a spindle motor 100 according an embodiment of the present invention may include the shaft 110 fixed to a base 190, a fixed member and the rotor hub 120 including a compensating part 126, and may further include upper and lower thrust parts 130 and 140 and a seal part 150, a rotating member.

The base 190 may be a fixed member that supports a rotation of the rotating member with respect to the rotating member including the rotor hub 120.

In this configuration, a predetermined space may be formed between the base 190 and the rotor hub 120 and the space may be provided with a core 170 around which a coil 160 is wound.

That is, the base 190 may be provided with a core coupling part 152 extending upwardly in the axial direction, and the core 170 around which the coil 160 is wound may be insertedly fixed to an outer circumferential surface of the core coupling part 152.

The shaft 110 may be indirectly fixed to the base 190 via the lower thrust part 140 and may configure the fixed member, together with the lower thrust part 140 and the upper thrust part 130.

Here, the shaft 110 may be inserted into a hole formed in a disk part 142 of the lower thrust part 140 and may be fixed by at least one of press-fitting, welding, and bonding.

Further, the shaft 110 is depressed inwardly from an outer circumferential surface and may be provided with a separating groove 112 allowing oil O provided in a gap between the shaft 110 and the rotor hub 120 to be separated upwardly and downwardly in the axial direction.

The separating groove 112 may have a “V”-shaped cross-section, and the separating groove 112 may form interfaces I1 and I2 of the oil O, together with an inner circumferential surface of the rotor hub 120.

In addition, FIG. 1 illustrates that the shaft 110 is fixed to the lower thrush part 140 so as to be indirectly fixed to the base 190, but the present invention is not necessarily limited thereto. The shaft 100 may be directly fixed to the base 190.

The rotor hub 120 may be rotatably mounted using the oil O while maintaining a gap from the shaft 110 and may be provided with a disk D, a recording medium.

That is, the rotor hub 120 mounted in the spindle motor 100 according to the embodiment of the present invention may include both sleeve and hub functions according to the related art and may be provided with a through hole 128 into which the shaft 110 is inserted, so as to be rotatably mounted on the shaft 110.

Therefore, the embodiment of the present invention may replace the sleeve and the hub according to the related art with the rotor hub 120 as a single component to reduce the number of components, improve productivity, and significantly reduce manufacturing tolerances.

Further, repeatable run out (RRO) may be reduced by the rotor hub 120 in which the sleeve and the hub according to the related art are integrated, to significantly reduce micro vibrations, thereby significantly increasing the performance of the spindle motor.

In detail, the rotor hub 120 may include a body part 122 maintaining a gap from the shaft 110 and forming bearing gaps B1 and B2 with the shaft 110 and a magnet support part 124 extending in the outer radial direction from the body part 122 and having the disk D and a magnet assembly 180 mounted thereon.

When the rotor hub 120 is rotatably mounted on the shaft 110, the body part 122 of the rotor hub 120 may be provided with the bearing gaps B1 and B2 so that a gap between the inner circumferential surface of the rotor hub 120, that is, an inner circumferential surface of the body part 122 and an outer circumferential surface of the shaft 110 form a fluid dynamic bearing.

Here, in describing the bearing gaps B1 and B2 in detail, the bearing gaps B1 and B2 may be configured of an upper bearing gap B1 and a lower bearing gap B2.

The upper and lower bearing gaps B1 and B2 may be formed upwardly and downwardly in the axial direction based on the separating groove 112 formed in the shaft 110, and an upper portion of the separating groove 112 may be provided with a first fluid-air interface I1, an interface between oil O and air provided in the upper bearing gap B1.

Further, a lower portion of the separating groove 112 may be provided with a second fluid-air interface I2, an interface between oil O and air provided in the lower bearing gap B2.

As described above, the separating groove 112 may have a “V” shape, which is to prevent the oil from being leaked due to a capillary phenomenon.

Here, in order to form the first fluid-air interface I1 and the second fluid-air interface I2, the oil O provided in the upper bearing gap B1 and the lower bearing gap B2 needs to contact air.

Therefore, the body part 122 of the rotor hub 120 may be provided with a communicating part 121 allowing the separating groove 112 to be in communication with the outside.

That is, the separating groove 112 and the outside of the rotor hub 120 may have the same pressure due to the communicating part 121.

Here, as illustrated in FIGS. 1 and 2, the communicating part 121 may be inclined downwardly in the outer radial direction, but is not limited thereto. The communicating part 121 may be inclined upwardly in the outer radial direction or may be horizontally formed.

Meanwhile, the communicating part 121 is formed in the rotor hub 120 while having a hole shape and therefore, the mass of the rotor hub 120 is reduced by a volume of the communicating part 121, thereby causing the mass unbalance when the rotor hub 120 rotates.

In other words, the rotor hub 120 needs to have a symmetrical mass based on the rotational center thereof to implement stable rotational characteristics, but when the communicating part 121 is formed, the portion of the rotor hub 120 in which the communicating part 121 is formed has a slightly reduced mass, as compared to a portion corresponding thereto based on the rotational center.

Consequently, when the rotor hub 120 rotates, this causes a problem in that the rotor hub 120 is biased and rotated based on the rotational center, thereby degrading the rotational characteristics.

However, the spindle motor 100 according to the embodiment of the present invention may include the compensating part 126 so as to compensate for the mass unbalance of the rotor hub 120 due to the communicating part 121.

That is, the compensating part 126 may be formed symmetrically with the communicating part 121 formed in the rotor hub 120, based on the rotational center of the rotor hub 120. The compensating part 126 may be formed by allowing a predetermined area to be depressed.

Here, the volume of the compensating part 126 may be equal to that of the communicating part 121.

Therefore, the rotor hub 120 makes the mass reduction generated due to the communicating part 121 uniform by using the compensation part 126 formed symmetrically with the communicating part 121 based on the rotational center, thereby implementing the symmetrical mass distribution based on the rotational center.

Therefore, the spindle motor 100 according to the embodiment of the present invention may utilize the compensating part 126 to improve the rotational instability due to the communicating part 121 when the rotor hub 120 is rotated at high speed.

Here, the compensating part 126 may be formed outwardly of at least one of the upper thrust part 130 and the lower thrust part 140 in the radial direction, but is not necessarily limited thereto and it is to be noted that the compensating part 126 may be formed in a position allowing the mass unbalance due to the communicating part 121 to be compensated for, without limitation.

Further, when the oil O is injected into the spindle motor 100 according to the embodiment of the present invention, the compensating part 126 may guide the position of the oil injection so as to prevent the oil O from being filled in the communicating part 121.

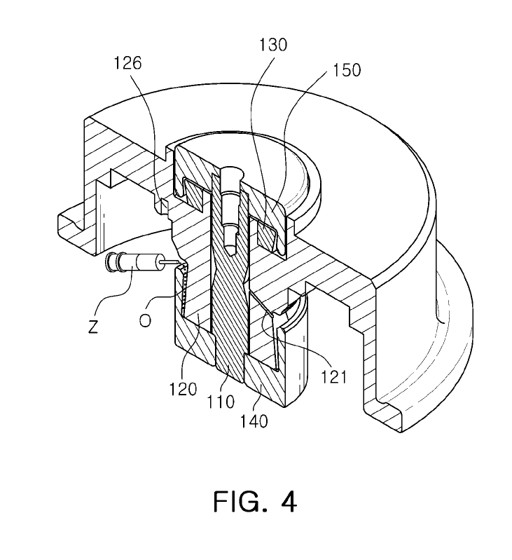

This will be described in detail with reference to FIG. 4.

Meanwhile, at least one of the inner circumferential surface of the body part 122 of the rotor hub 120 and the outer circumferential surface of the shaft 110 may be provided with a fluid dynamic pressure part 123 and the fluid dynamic pressure part 123 may generate radial dynamic pressure via the oil O.

That is, at least one of the inner circumferential surface of the body part 122 of the rotor hub 120 and the outer circumferential surface of the shaft 110 that form the upper and lower bearing gaps B1 and B2 may be provided with a groove having a herringbone shape, a spiral shape, or a helical (screw) shape to generate the radial dynamic pressure that supports the rotation of the rotor hub 120 via the oil O.

Meanwhile, the magnet support part 124 of the rotor hub 120 may be coupled to the magnet assembly 180 and the disk D.

That is, an inner circumferential surface of the magnet support part 124 may be coupled to the magnet assembly 180 and an outer circumferential surface thereof may have the disks D insertedly mounted thereon, the disks being spaced apart from each other by a spacer S.

Meanwhile, the magnet assembly 180 may be configured of a yoke 184, fixed to the inner circumferential surface of the magnet support part 124 and a magnet 182, mounted on an inner circumferential surface of the yoke 184.

The yoke 184 may serve to direct a magnetic field from the magnet 182 to the core 170 around which the coil 160 is wound to increase magnetic flux density.

Meanwhile, the yoke 184 may have a circular ring shape and may have a bent edge so that the magnetic flux density may be improved by the magnetic field generated from the magnet 182.

Here, the magnet 182 may have an annular shape and may be a permanent magnet generating a magnetic field having a predetermined magnitude by alternately magnetizing an N pole and an S pole in a circumferential direction.

Meanwhile, the magnet 182 is disposed to face a front end of the core 170 around which the coil 160 is wound and generates driving force by electromagnetic interaction with the core 170 having the coil 160 wound therearound to thereby rotate the rotor hub 120.

That is, when power is supplied to the coil 160, the driving force is generated by electromagnetic interaction between the core 170 around which the coil 160 is wound and the magnet 182 disposed to be opposite thereto, so that the rotor hub 120 may be rotated based on the shaft 110.

The upper thrust part 130 and the lower thrust part 140 may form the fluid-air interface, together with the seal part 150 and the body part 122 of the rotor hub 120, and be coupled to the shaft 110 to configure the fixed member together with the shaft 110.

Here, prior to describing the upper thrust part 130, the lower thrust part 140 will first be described.

The lower thrust part 140 may be inserted into the base 190, and, in more detail, the outer circumferential surface of the lower thrust part 140 may be bonded to an inner circumferential surface of the core coupling part 152 of the base 190.

Meanwhile, the inner circumferential surface of the lower thrust part 140 may be fixed to a lower end of the shaft 110, in detail, the lower thrust part 140 may include the disk part 142 coupled to the shaft 110 and a wall part 144 extending upwardly in the axial direction from the disk part 142.

That is, the lower thrust part 140 may have a hollow cup shape having a central hole and a “└” shaped section in the axial direction and the lower thrust part 140 may be continuously formed in a circumferential direction.

Meanwhile, the outer circumferential surface of the lower thrust part 140 may be coupled to the inner circumferential surface of the core coupling part 152 of the base 190 by at least one of welding, bonding, and press-fitting.

Further, at least one of an upper surface of the lower thrust part 140 or a bottom surface of the body part 122 of the rotor hub 120 may be provided with a thrust dynamic pressure part (not illustrated) so as to generate thrust dynamic pressure.

Here, an interface between the oil O and air, that is, a fourth fluid-air interface I4 may be formed between the inner circumferential surface of the wall part 144 of the lower thrust part 140 and the outer circumferential surface of the body part 122 of the rotor hub 120.

In detail, the outer circumferential surface of the body part 122 of the rotor hub 120 facing the wall part 144 may be inclined upwardly in the inner radial direction so as to form the fourth fluid-air interface I4.

Therefore, the oil O provided in the lower bearing gap B1 forms the second fluid-air interface I2 and the fourth fluid-air interface I4.

The upper thrust part 130 ma be coupled to an upper end of the shaft 110, and in more detail, may include a fastening part 132 coupled to the shaft 110 while being disposed on the upper surface of the body part 122 of the rotor hub 120 and an extension part 134 extending downwardly in the axial direction from the fastening part 132.

That is, a cross section of the upper thrust part 130 in the axial direction may have a “┐” shape and the upper thrust part 130 may be continuously formed in a circumferential direction.

Meanwhile, the upper thrust part 130 may be bonded to the shaft 110 by at least one of welding, bonding, and press-fitting.

Further, at least one of a bottom surface of the fastening part 132 of the upper thrust part 130 or the upper surface of the body part 122 of the rotor hub 120 may be provided with a thrust dynamic pressure part (not illustrated) so as to generate thrust dynamic pressure.

Here, an interface between the oil O and air, that is, a third fluid-air interface I3 may be formed between an inner circumferential surface of the extension part 134 of the upper thrust part 130 and the seal part 150 coupled to the upper portion of the rotor hub 120.

Therefore, the oil O provided in the upper bearing gap B1 forms the first fluid-air interface I1 and the third fluid-air interface I3.

In detail, the seal part 150 for forming the third fluid-air interface I3 may be continuously formed in a circumferential direction and be fixed to the rotor hub 120, and the outer circumferential surface of the seal part 150 facing the extension part 134 may be inclined downwardly in the inner radial direction so as to form the third fluid-air interface I3.

Therefore, the spindle motor 100 according to the embodiment of the present invention may effectively reduce the scattering of the oil O due to centrifugal force at the time of the rotation of the rotor hub 120.

FIG. 4 is a schematic cutaway perspective view illustrating an oil filling process of a spindle motor according to an embodiment of the present invention.

Referring to FIG. 4, in the spindle motor 100 according to the embodiment of the present invention, the shaft 110, the rotor hub 120, the seal part 150, the upper thrust part 130, and the lower thrust part 140 are coupled to each other and then, oil O is injected between the lower thrust part 140 and the rotor hub 120.

In this case, the oil O may be injected by an oil filling machine Z.

Here, when the oil O is injected, the communicating part 121 formed in the rotor hub 120 should not be filled with the oil O. If the communicating part 121 is filled with the oil O, it may be difficult to communicate with the outside, such that a problem associated with the formation of the first and second fluid-air interfaces I1 and I2 may occur.

Further, the fluid-air interface I4 (see FIG. 2) of the oil O injected between the lower thrust part 140 and the rotor hub 120 may not be substantially confirmed, such that a fixed amount of oil O may be supplied using a weight difference after and before the oil O stored in the oil filling machine Z is injected.

However, if the oil O injected by the oil filling machine Z is filled in the communicating part 121, even in the case in which a fixed amount of oil O is injected by the weight difference after and before the oil O stored in the oil filling machine Z is injected, a fixed amount of oil O is not substantially injected between the lower thrust part 140 and the rotor hub 120.

Further, if the oil O injected by the oil filling machine Z is filled in the communicating part 121, the oil O moved to the communicating part 121 by centrifugal force due to the rotation of the rotor hub 120 is leaked to the outside and thus, it may pollute the disk D on which data is stored.

This may cause the degradation in rotational characteristics and performance of the spindle motor 100 according to the embodiment of the present invention. Therefore, the oil O needs to be injected in a position of the rotor hub other than a portion of the rotor hub in which the communicating part 121 is formed.

However, the position of the communicating part 121 is difficult to identify from the outside and therefore, it is likely to inject the oil O into a portion of the rotor hub in which the communicating part 121 is formed.

However, the spindle motor 100 according to the embodiment of the present invention can previously prevent the foregoing possibility by the compensating part 126 formed in a position opposite to the position of the communicating part 121, that is, in a position symmetrical to the communicating part 121 based on the rotational center of the rotor hub 120.

In other words, when the oil O is provided by the oil filling machine Z, the position of the compensating part 126 is identified regardless of the communicating part 121, and when the oil O is injected in a position corresponding to the position of the compensating part 126, the oil O is naturally filled in a position other than a portion of the rotor hub in which the communicating part 121 is formed, such that the possibility that the oil O is injected into the communicating part 121 may be completely excluded.

Therefore, the spindle motor 100 according to the embodiment of the present invention may guide the injection position of the oil O by using the compensating part 126, thereby allowing the oil O to be safely and easily injected by utilizing the compensation part 126.

As set forth above, in a spindle motor according to embodiments of the present invention, the number of components configuring the spindle motor can be reduced to significantly reduce manufacturing tolerances while improving productivity.

Further, oil for a fluid dynamic bearing can be easily injected.

In addition, mass unbalance of a rotating member can be resolved to thereby implement stable rotational characteristics.

While the present invention has been shown and described in connection with the embodiments, it will be apparent to those skilled in the art that modifications and variations can be made without departing from the spirit and scope of the invention as defined by the appended claims.

What is claimed is:

1. A spindle motor, comprising:
a shaft directly or indirectly fixed to a base;
a rotor hub rotatably disposed via oil while maintaining a bearing gap from the shaft and including a communicating part in communication with the outside so that a fluid-air interface is formed between the rotor hub and the shaft; and
a compensating part formed by allowing a predetermined area of the rotor hub to be depressed so as to compensate for mass unbalance of the rotor hub due to the communicating part.

2. The spindle motor of claim 1, wherein the compensating part is symmetrically formed with regard to the communicating part, based on a rotational center of the rotor hub.

3. The spindle motor of claim 1, wherein the compensating part and the communicating part have the same volume.

4. The spindle motor of claim 1, further comprising an upper thrust part and a lower thrust part fixed to the shaft and allowing the fluid-air interface to be formed.

5. The spindle motor of claim 4, wherein the fluid-air interface formed in the upper thrust part is formed between the upper thrust part and a seal part coupled to the rotor hub.

6. The spindle motor of claim 5, wherein one surface of the seal part is inclined downwardly in an inner radial direction so as to form the fluid-air interface together with the upper thrust part.

7. The spindle motor of claim 4, wherein the compensating part is formed outwardly of at least one of the upper thrust part and the lower thrust part in a radial direction.

8. The spindle motor of claim 1, wherein the shaft is provided with a separating groove depressed inwardly from an outer circumferential surface thereof so as to allow the oil provided in a gap formed between the rotor hub and the shaft to be separated upwardly and downwardly in an axial direction.

9. The spindle motor of claim 8, wherein the communicating part is disposed to face the separating groove to allow the separating groove to be in communication with the outside, and
the fluid-air interface is formed in upper and lower portions of the separating groove in the axial direction.
